(19) United States
(12) Patent Application Publication
(10) Pub. No.: US 2016/0253861 A1
(43) Pub. Date: Sep. 1, 2016

(54) MULTI-KIOSK-BASED AUTOMATIC TTEOK VENDING MACHINE

(71) Applicant: NEW PURITECHNOLOGY CO., LTD., Gyeongsan-si Gyeongsangbuk-do (KR)

(72) Inventor: Sung-yong SEO, Gyeongsan-si, Gyeongsangbuk-do (KR)

(21) Appl. No.: 14/387,239

(22) PCT Filed: Jul. 10, 2014
(86) PCT No.: PCT/KR2014/006189

§ 371 Date: Sep. 23, 2014

(51) Int. Cl. G07F 13/06; G06Q 20/20; A47J 27/04; G06Q 20/18

(52) U.S. Cl. CPC G07F 13/06; G06Q 20/18; G06Q 20/202; A47J 27/04; A47J 2027/043

(57) ABSTRACT

A multi-kiosk-based automatic tteok vending machine is disclosed. In the multi-kiosk-based automatic tteok vending machine according to the present invention, one side of a tteok product container with the material of a corresponding tteok product airtightly packaged therein is bored and high-pressure steam is supplied into the bored tteok product container when a consumer selects a desired kind of tteok product so that tteok can be easily cooked on the spot to be provided, and a variety of information and services are additionally provided to consumers by a multi-kiosk system connected to an external server.

### BACKGROUND

1. Field of the Invention

The present invention relates to a multi-kiosk-based automatic tteok vending machine, and more particularly, to a multi-kiosk-based automatic tteok vending machine which may easily cook tteok on the spot to provide the cooked tteok by injecting a high-pressure steam, for a certain time, into a tteok product container with the ingredient of the corresponding tteok product airtightly packaged therein when a consumer selects a desired kind of tteok product, and additionally provide a variety of information and services to the consumer by a multi-kiosk system connected to an external server.

2. Discussion of Related Art

In recent years, there is an increased interest in Korean traditional food that is well-being food rather than high-fat junk food due to the heightened interest in food for health. Tteok of the Korean traditional food is processed food having cereals as the main material and thereby may be simply used as a meal substitute or snack food while reducing a risk such as accumulation of cholesterol.

However, in order to manufacture tteok, rice should be subjected to a process in which rice is soaked in water and ground to obtain rice flour and then the rice flour is steamed in a steamer, and therefore the manufacturing time of tteok is relatively longer than that of Western fast food that is quickly cooked on the spot such as hamburger.

Thus, despite many advantages in terms of nutrition and health compared to Western fast food, tteok manufactured in the related art cannot be quickly cooked on the spot as described above whenever there is a request of a purchaser, and therefore there is a problem that tteok cannot be widespread to modern people who become accustomed to quick and simple dietary life.

In order to solve these problems, a tteok manufacturing apparatus in which tteok packaged individually in a tteok cooking vessel is cooked on the spot using steam generated from a steam generating device has been recently developed, and is disclosed in detail in the following Document 1, etc., which has been filed by the applicant of the present invention.

However, the instant tteok manufacturing apparatus disclosed in the following Document 1 has a problem that an operator of the tteok manufacturing apparatus should be always on standby in order for a consumer to use the tteok manufacturing apparatus. In addition, the instant tteok manufacturing apparatus has a configuration in which a steam supply pipe is installed on one side of the tteok cooking vessel, and therefore it is likely to cause decomposition of the ingredients of tteok due to unreliable sealing of the tteok cooking vessel.

[Document 1] Korean Registered Patent No. 1063873 (Issued Sep. 8, 2011)

### SUMMARY OF THE INVENTION

The present invention is directed to a multi-kiosk-based automatic tteok vending machine which may be provided in the form of a vending machine, in which one side of a tteok product container with the material of a corresponding tteok product airtightly packaged therein may be bored and high-pressure steam may be supplied into the bored tteok product container when a consumer selects a desired kind of tteok product so that tteok can be easily cooked on the spot to be provided, and in which the tteok product container may be sealed so that it is possible to prevent decomposition of the ingredient of the tteok.

The present invention is directed to a multi-kiosk-based automatic tteok vending machine which may additionally provide a variety of information and services to consumers by a multi-kiosk system connected to an external server as well as the above-described function of the tteok vending machine.

According to an aspect of the present invention, there is provided a multi-kiosk-based automatic tteok vending machine including: a tteok product selection unit that is installed on one side of an outer surface of a box-like main body and in which signals for selecting at least any one menu of tteok products being on sale are input; a tteok product preserving unit that preserves, in an internal space of the main body, a product container in which a material of each of the tteok products is individually and airtightly packaged, and discharges the product container in which a corresponding tteok product is packaged when the menu of the tteok product is selected; and a tteok manufacturing unit that cooks the tteok product by supplying steam into the product container discharged from the tteok product preserving unit in the internal space of the main body. Here, the tteok manufacturing unit may include a steam generating device for generating high-temperature steam and a steam discharging device for supplying the generated steam into the product container to cook the tteok product, and the steam may be supplied in a state in which the steam discharging device bores one side of the product container and at least a part of the steam discharging device is inserted into the product container.

Also, the tteok manufacturing unit may further include a container transport device for transporting the product container discharged from the tteok product preserving unit to the steam generating device and transporting the product container in which cooking of the tteok product is completed to a product discharge unit formed on the outer surface of the main body, the steam discharging device may include a steam discharge pipe that discharges the steam generated in the steam generating device to the outside, a flange that is formed in an end portion of the steam discharge pipe so that the product container is seated on the flange, and a plurality of steam discharge pins which are installed so as to protrude in the form of pins from a bottom surface of the flange to branch and discharge the steam of the steam discharge pipe, and the container transport device may transport the product container to the flange to seat the product container in the flange and then pressure the product container downward so that the steam discharge pins bore a seated surface of the product container and are inserted into the product container.

Also, the multi-kiosk-based automatic tteok vending machine may further include an information selection unit that is installed on one side of the outer surface of the main body and in which signals for selecting at least any one menu of information being provided either for free or for pay are input; and an additional product selection unit that is provided on one side of the outer surface of the main body and in which signals for selecting at least any one menu of other additional products being on sale are input.

Also, the multi-kiosk-based automatic tteok vending machine may further include a display unit that is installed on one side of the outer surface of the main body. Here, the display unit may display, when at least any one menu is selected in the tteok product selection unit, the information selection unit, or the additional product selection unit, information related to the selected menu.

Also, the display unit may be configured in a touch screen scheme, and the tteok product selection unit, the information selection unit, or the additional product selection unit may be displayed on a screen of the display unit so that the menu is selected by a touch.

Also, the multi-kiosk-based automatic tteok vending machine may further include a ticket issuing unit that is provided on one side of the outer surface of the main body to issue and provide the additional product being on sale in a ticket format.

Also, the multi-kiosk-based automatic tteok vending machine may further include a settlement unit that settles payment of the menu selected in the tteok product selection unit, the information selection unit, or the additional product selection unit. Here, the settlement unit may include at least any one of a voucher settlement machine in which payment is performed by a voucher, a mobile phone settlement machine in which payment is performed by a mobile phone terminal, a cash settlement machine in which payment is performed by cash such as coins or bills, and a credit card settlement machine in which payment is performed by a credit card or the like.

Also, the multi-kiosk-based automatic tteok vending machine may further include a communication unit that communicates with an external server. Here, the external server may be a server operated by at least any one of an agency for providing information of the menu selected in the information selection unit, an agency for selling the additional product selected in the additional product selection unit, an agency for processing payment by the mobile phone terminal, an agency for processing payment by the credit card, and an agency for doing business for these agencies.

Also, the tteok product preserving unit may include a freezing chamber for freezing and preserving the product container and a refrigerating chamber for refrigerating and preserving the product container, and the freezing chamber may discharge the product container of the selected tteok product to the refrigerating chamber when the product container of the selected tteok product is discharged from the refrigerating chamber by selection of the menu of the tteok product.

Also, the steam generating device may include a water tank with water accommodated therein, and a heating device that is installed on one side of the water tank to heat water inside the water tank by electromagnetic induction.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a perspective view showing an external configuration of a multi-kiosk-based automatic tteok vending machine according to an exemplary embodiment of the present invention;

FIG. 2 is a view showing an internal configuration of the multi-kiosk-based automatic tteok vending machine shown in FIG. 1;

FIG. 3 is a cross-sectional view of an A-A portion of FIG. 2;

FIG. 4 is a cross-sectional view of a B-B portion of FIG. 2;

FIG. 5 is a cross-sectional view of a C-C portion of FIG. 2;

FIG. 6 is a cross-sectional view of a D-D portion of FIG. 4;

FIG. 7 is a partially enlarged perspective view of a steam generating device shown in FIG. 2; and

FIG. 8 is a block diagram showing an operational configuration of a multi-kiosk-based automatic tteok vending machine according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

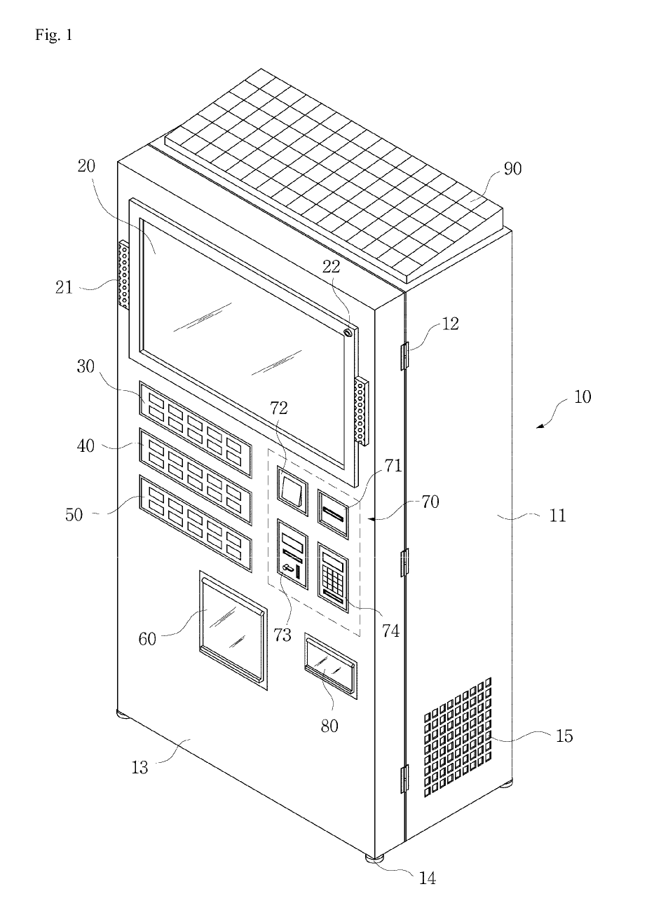

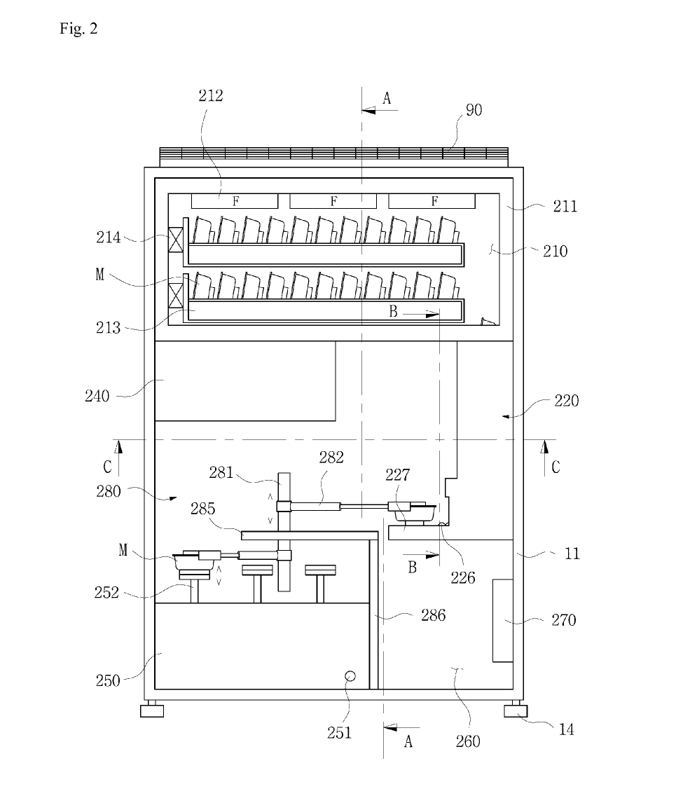

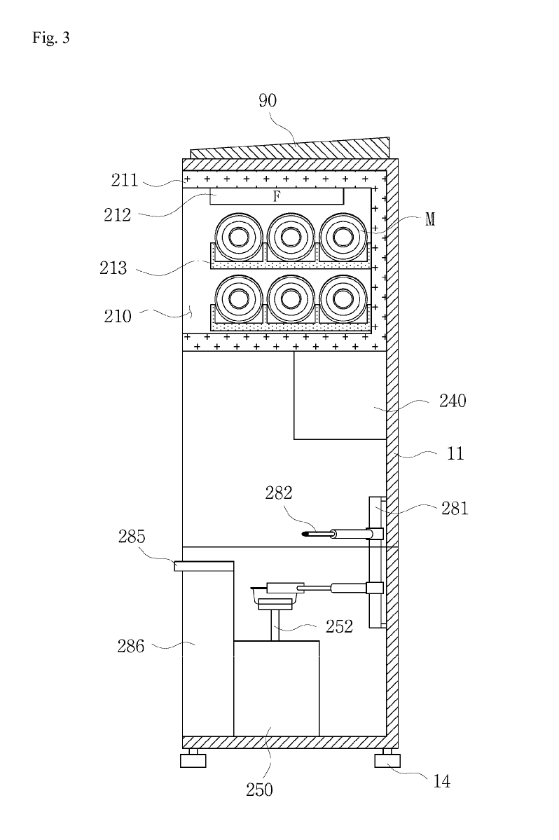

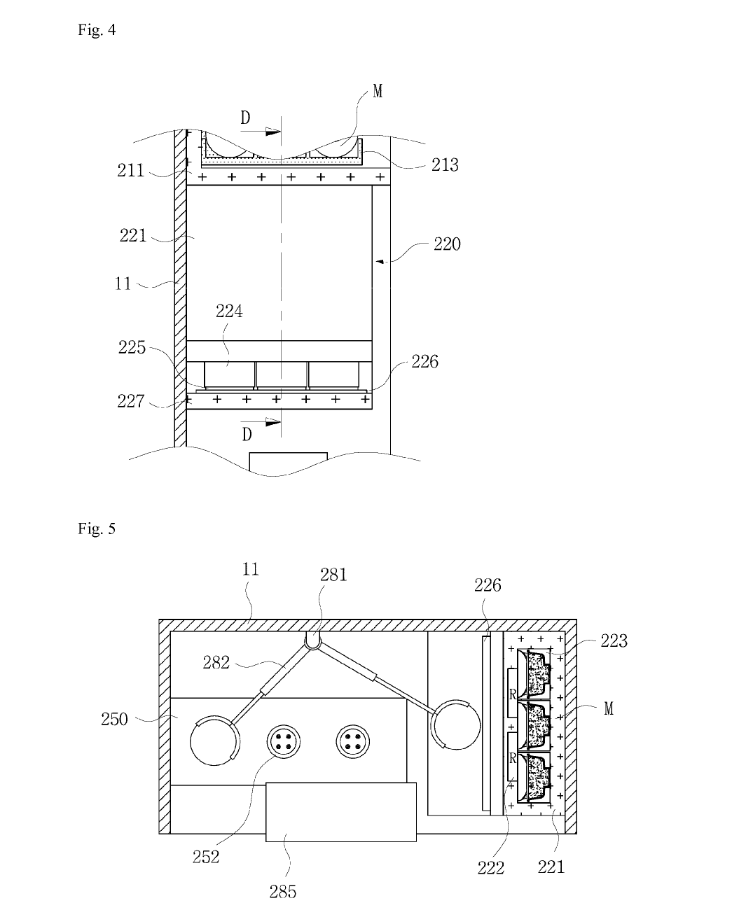

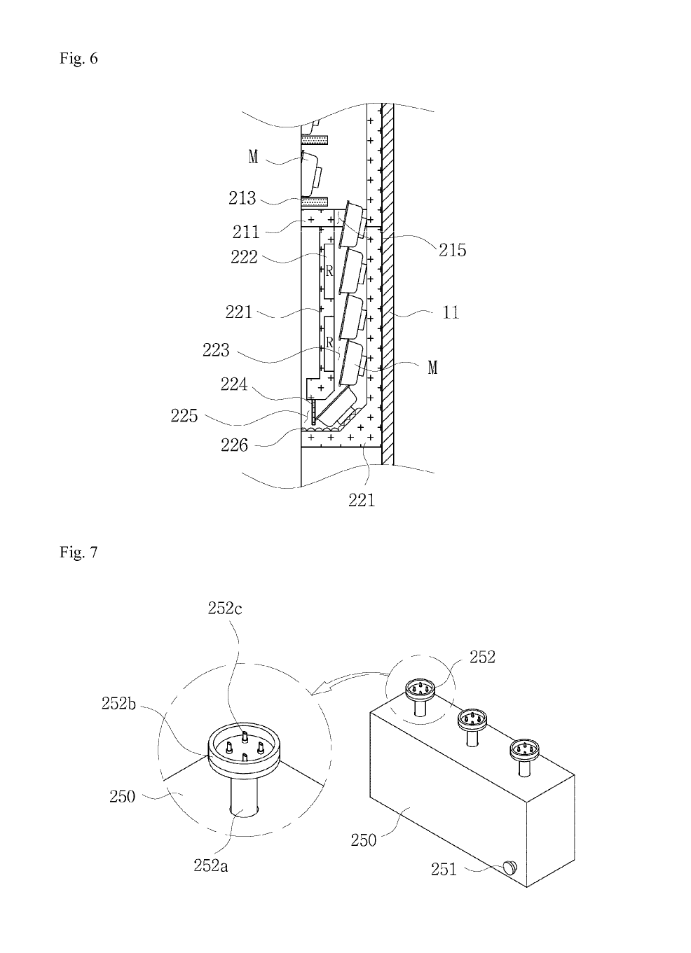

FIG. 1 is a perspective view showing an external configuration of a multi-kiosk-based automatic tteok vending machine according to an exemplary embodiment of the present invention, and FIG. 2 is a view showing an internal configuration of the multi-kiosk-based automatic tteok vending machine shown in FIG. 1. In addition, FIGS. 3 to 5 are cross-sectional views of an A-A portion, a B-B portion, and a C-C portion of FIG. 2, FIG. 6 is a cross-sectional view of a D-D portion of FIG. 4, and FIG. 7 is a partially enlarged perspective view of a steam generating device shown in FIG. 2.

The multi-kiosk-based automatic tteok vending machine according to the present invention includes a box-like main body unit 10, display units 20 respectively formed on one side of the main body unit 10, a tteok product selection unit 30, an information selection unit 40, an additional product selection unit 50, a product discharge unit 60, a settlement unit 70, a ticket issuing unit 80, and a tteok manufacturing unit 200 that is installed inside the main body unit 10.

In addition, the main body unit 10 includes a space in which the tteok manufacturing unit 200 is accommodated, a box-like main body 11 whose front surface is opened, a door 13 that is coupled to the main body 11 by a hinge structure 12 or the like to open and close the opened front surface of the main body 11, a height adjustment means 14 that is installed on a bottom unit of the main body 11 to adjust a height, and an exhaust hole 15 that is formed on one side of the side surface of the main body 11 to discharge air of an internal space of the main body to the outside.

In this instance, the main body unit 10 is made of at least any one material of plastic and metal materials, and a sunlight generation unit 90 that generates power using sunlight to supply operating power to the tteok vending machine according to the present invention may be installed on at least one of an upper surface, a side surface, and a rear surface of the main body unit 10, as necessary.

In addition, in the present embodiment, the display unit 20, the tteok product selection unit 30, the information selection unit 40, the additional product selection unit 50, the product discharge unit 60, the settlement unit 70, the ticket issuing unit 80, and the like which will be described later are formed on one side of the outer surface of the door 13 for convenience of description, but the present invention is not limited thereto. Obviously, these units may be installed on another side of the main body unit 10, as necessary.

Meanwhile, the display unit 20 is a device for displaying a variety of information and advertisements, and the like which are required for a user, and may be preferably implemented as any one of known normal display devices. As an example, in the present embodiment, the display unit 20 is provided in the form of a touch screen.

In addition, on one side of the display unit 20, a speaker 21 for providing voice information to a user and a camera 22 for photographing a peripheral environment of the tteok vending machine including the user may be further installed, as necessary.

In addition, in the tteok product selection unit 30, signals for selecting a user's favorite tteok product by the user are input, and a plurality of menu switches on which the tteok products provided by the tteok vending machine according to the present invention are displayed may be configured in at least any one of a mechanical button scheme and a touch screen scheme.

As an example, the tteok product may include hobaktteok, ssuktteok, baekseolgi, kongtteok, and the like depending on the kind of the sub material, and a variety of patterns may be marked on the tteok product so that the tteok product may be provided in an anniversary or event, as necessary.

In addition, in the information selection unit 40, signals for requesting information required for a user by the user other than selection of the tteok product are input, and a plurality of menu switches on which information provided by the tteok vending machine according to the present invention is displayed may be configured in at least any one of a mechanical button scheme and a touch screen scheme.

As an example, the information may include news information such as politics, economy, culture, and sports, and information related to transportation, tourism, climate, history, specialties, restaurants, and the like of a region in which the tteok vending machine is installed, and may be stored in advance in a memory unit 110 which will be described later or received from an external server 300 connected through a communication unit 120 by a method applied to a normal kiosk system.

In addition, communication between the communication unit 120 and the external server 300 which is applied in the detailed description and claims of the present invention may be performed in a method applied to the above-described normal kiosk system.

In addition, the information may be free information, but include charged information such as stock information, academic information, property information, and the like depending on the kind of information. In addition, in the additional product selection unit 50, signals for selecting other additional products required for a user by the user other than the tteok products are input, and a plurality of menu switches on which additional products provided by the tteok vending machine according to the present invention are displayed may be configured in at least any one of a mechanical button scheme and a touch screen scheme.

As an example, the additional products may include specialties of a region in which the tteok vending machine is installed, lotteries, vouchers, tickets of public transportation such as train or bus, tickets of nearby parks and museums, tickets of ongoing performances or sporting events, and the like, and may be reserved or sold by the external server 300 connected through the communication unit 120 by the method applied to the normal kiosk system.

In addition, the reserved or sold additional product may be provided directly to a user through the product discharge unit 60 which will be described later, or may be delivered to a designated address or the like when the additional product is selected by the user.

In addition, in the present embodiment, as an example, a case in which the tteok product selection unit 30, the information selection unit 40, and the additional product selection unit 50 are installed separately from the display unit 20 has been described, but the present invention is not limited thereto. The menu switches of the tteok product selection unit 30, the information selection unit 40, and the additional product selection unit 50 may be displayed on one side of the screen of the display unit 20 provided in the touch screen scheme, as necessary, so that a required menu is selected by a user's touch.

Meanwhile, through the product discharge unit 60, a product selected by the user is discharged in the same manner as in the normal vending machine, and in the present embodiment, the tteok product selected in the tteok product selection unit 30 may be discharged.

In addition, when the additional product selected in the additional product selection unit 50 is in a ticket format such as a transportation pass, a ticket for entrance, an admission ticket, or the like, the ticket issuing unit 80 issues the additional product, and may sell and issue the corresponding additional product by communicating with the external server 300 connected through the communication unit 120 by the method applied to the normal kiosk system.

In addition, the settlement unit 70 may settle payment of the tteok product, charged information, the additional product, and the like which have been selected in the tteok product selection unit 30, the information selection unit 40, and the additional product selection unit 50, and in the present embodiment, the settlement unit 70 may include a voucher settlement machine 71 in which payment is performed by a voucher (department store voucher, onnuri voucher, culture voucher, and the like), a mobile phone settlement machine 72 in which payment is performed by a mobile phone terminal, a cash settlement machine 73 in which payment is performed by cash such as coins or bills, and a credit card settlement machine 74 in which payment is performed by a credit card or the like depending on the settlement method.

In this instance, when the payment is performed by the voucher, the mobile phone terminal, the credit card, or the like, the settlement unit 70 may be configured in such a manner that procedures such as authentication, payment authorization, and the like are achieved by communicating with the external server 300 connected through the communication unit 120 by the method applied to the normal kiosk system.

In this case, the external server 300 may be a server operated by a financial institution such as a voucher issuer, a mobile phone carrier, or a credit card company, or a server operated by a person who does business for these, and the payment may be performed by a communication point of a mobile phone terminal or an accumulation point of a credit card depending on the user's selection.

In addition, the additional product selection unit 50 may further include a menu for donating a user's cash, voucher, communication point, credit card accumulation point, or the like to an external institution or the like as well as purchase of the additional product, and in this case, the donation action of the user may be photographed by the camera 22 to be known to the outside through the display unit 20 and/or the speaker 21, as necessary.

Meanwhile, the tteok manufacturing unit 200 installed in the internal space of the main body unit 10 includes a freezing chamber 210 that is installed in an upper portion of the internal space of the main body unit to freeze and preserve a tteok product container M in which tteok materials depending on the kind of the tteok product are airtightly packaged as individual containers, a refrigerating chamber 220 that is installed on one side of a lower portion of the freezing chamber 210 to refrigerate and preserve the tteok product container M, a cold air generating device 240 that generates cold air supplied to the freezing chamber 210 and the refrigerating chamber 220, a steam generating device 250 that is installed in a lower portion of the internal space of the main body unit to generate steam required for cooking of the tteok product, and an exhaust fan 270 that is installed in a location corresponding to the exhaust hole 15 in the internal space of the main body unit.

In addition, in the detailed description and claims of the present invention, as an example, a case in which the tteok material is packaged in the tteok product container M has been described, but the present invention is not limited thereto. For example, the tteok product container M may be a product container including food materials which can be cooked on the spot by steam such as sweet potatoes, potatoes, rice, corn, etc., as necessary.

However, in this case, it is preferable that the tteok product container M and the tteok vending machine according to the present invention be referred to as a product container in which the corresponding food material is packaged and the vending machine of the corresponding food material, respectively.

In addition, the tteok manufacturing unit 200 may further include a tteok product transport unit 280 that grips the tteok product container M discharged sequentially from the refrigerating chamber 220, transports the tteok product container M to the steam generating device 250 to cook the tteok product by steam supply, and then discharge the tteok product container M in which cooking of the tteok product is completed to the product discharge unit 60.

In this instance, the freezing chamber 210 is a space partitioned by a freezing chamber housing 211 installed inside the main body 11, and includes a freezing heat exchanger 212 for supplying cold air, loading shelves 213 with a plurality of rows in which the tteok product container M is loaded/preserved, a product discharge device 214 that is installed on one side of the loading shelves 213 to sequentially discharge the tteok product container M, and first through-holes 215 which are formed on one side of the bottom surface of the freezing chamber 210 to communicate with the refrigerating chamber 220 and through which the tteok product container M discharged sequentially from each of the loading shelves 213 is supplied to the refrigerating chamber 220.

In addition, it is preferable that the freezing chamber housing 211 be made of a heat insulating material and the freezing chamber housing 211 may be sealed in a state in which the door 13 of the main body unit 10 is opened, but a sealed space for the freezing chamber 210 may be formed when the door 13 is closed in order to facilitate storage of the tteok product container M.

In addition, the freezing heat exchanger 212 may be installed on one side of the freezing chamber 210 using a normal heat transfer device including a heat transfer area, but in the present embodiment, the freezing heat exchanger 212 may be installed on a ceiling surface of the freezing chamber 210 in order to improve efficiency of heat transfer and facilitate storage of the tteok product container M.

In addition, the loading shelves 213 and the product discharge device 214 may be preferably implemented using any one of systems configured to sequentially supply products from a normal showcase device, but in the present invention, as an example, the loading shelves 213 and the product discharge device 214 may discharge the tteok product container M from the side surface of one side of the main body unit 10 toward a side surface direction of the other side thereof.

Such a product discharge system is known technology which is generally used in vending machines or showcase fields, and therefore the detailed description thereof will be omitted. Obviously, the freezing chamber 210 may be configured to discharge the tteok product container M in a longitudinal direction (that is, vertical direction) of the main body unit 10, as necessary.

Meanwhile, the refrigerating chamber 220 is a space partitioned by a refrigerating chamber housing 221 installed in a lower portion of the freezing chamber housing 211 inside the main body 11, and includes a refrigerating heat exchanger 222 for supplying cold air, product discharge pipes 223 with a plurality of columns, which are formed in the form of a vertical channel in the lower portion of each of the first through-holes 215 and in which the tteok product container M is loaded/preserved in a vertical direction, second through-holes 225 which are formed in a lower portion of the product discharge pipe 223 and through which the tteok product container M is discharged, blocking plates 224 which are installed in lower outlets of the product discharge pipes 223 to control discharge of the tteok product container M through the second through-holes 225 by opening and closing of the blocking plates 224, and a product discharge roller 226 which is formed on a bottom surface of a lower outlet of the product discharge pipe 223 to assist discharge of the tteok product container M through the second through-holes 225.

In addition, the refrigerating chamber housing 221 is preferably made of a heat insulating material, and may be provided on one side of the freezing chamber using a normal heat transfer device including a heat transfer area. As an example, in the present invention, the refrigerating heat exchanger 222 may be installed on one side of the refrigerating chamber housing 221 in an embedded form.

In addition, the product discharge pipe 223 may be partitioned into a plurality of channels by the refrigerating chamber housing 221, and each channel is formed in such a manner that entrance of each channel communicates with each of the first through-holes 215 positioned in a corresponding position, so that the tteok product container discharged from the freezing chamber 210 is discharged through the second through-holes 225 by a self load in a state of being loaded in a longitudinal direction (that is, vertical direction) of the main body unit 10.

In addition, in a lower outlet of the product discharge pipe 223 on which the second through-holes 225 are formed, a panel-shaped tteok product seating portion 227 which is extended in a direction parallel to the bottom surface of the main body unit 10 from the product discharge pipe 223 is formed, so that the tteok product container M discharged through the second through-holes 225 is seated on the tteok product seating portion 227.

In addition, the cold air generating device 240 is installed on one side of the internal space of the main body unit 10 to generate cold air supplied to the freezing chamber 210 and the refrigerating chamber 220, and may be preferably implemented using a normal refrigeration cycle, a heat accumulator, a thermoelectric element, or the like.

Meanwhile, the tteok product containers M stored in the freezing chamber 210 are sequentially supplied to the refrigerating chamber 220 by the above-described method by the same number of tteok product containers M as the number of tteok product containers M discharged from the refrigerating chamber 220, and then is subjected to a defrosting process (as an example, natural defrosting in the refrigerating chamber).

In this case, in the present embodiment, although not described in detail, the tteok manufacturing unit 200 may further include a sensor (not shown) for determining a defrosting state of the tteok product container M discharged from the refrigerating chamber 220, and a control unit 100 which will be described later may control a temperature of steam supplied to the tteok product container M, a supply time of the steam, and the like based on the determination result of the sensor in a predetermined method.

In this instance, as an example, the sensor for determining the defrosting state may sense the strength or temperature of the tteok product container M.

In addition, the refrigerating chamber 220 may further include a reader (not shown) for recognizing a unique identification number described in a product label or the like of the supplied tteok product container M such as a bar code or a QR code, and the reader (not shown) determines a time when the corresponding tteok product container M is supplied to the refrigerating chamber 220 using the above-described unique identification number of the tteok product container M and a timer (not shown) to store or transmit the supplied time of the corresponding tteok product container M to the external server 300 (in this case, device management server) through the communication unit 120.

In this manner, when the time when the tteok product container M is supplied to the refrigerating chamber 220 is determined, the control unit 100 which will be described later may perform a procedure of discarding the tteok product container M whose shelf life has expired or by an instruction of the external server 300.

In addition, the tteok manufacturing unit 200 may further include a counter (not shown) for calculating the number of tteok product containers discharged from the refrigerating chamber 220 generally or for each kind of the tteok product, and the calculation result of the counter (not shown) is transmitted to the external server 300 through the communication unit 120, and therefore the external server 300 remotely determines the total stock of the tteok product containers M to supplement the products or the like, which is the same even in the above-described ticket issuing unit 80 (however, in this case, information about remaining amount of paper for issuing the corresponding ticket is transmitted to the corresponding external server).

In addition, the tteok manufacturing unit 200 may further include a defrosting device (not shown) that defrosts the non-defrosted tteok product container M discharged from the refrigerating chamber 220, as necessary.

In addition, the steam generating device 250 is a device that cooks the tteok material inside the tteok product container M by injecting, into the tteok product container M, high-temperature/high-pressure steam obtained by heating water accommodated in the steam generating device 250, and in the present embodiment, the steam generating device 250 includes a box-like water tank (not shown) in which water is accommodated and a heating device (not shown) installed on one side of the water tank.

In this case, in the heating device (not shown), a normal heater may be installed inside the water tank (not shown), but in the present embodiment, the normal heater may be provided as an induction heater that is installed on one side of the water tank for safety reasons to heat water inside the water tank by an electromagnetic induction phenomenon.

In addition, it is preferable that a water supply pipe 251 for supplying or discharging water accommodated in the water tank be formed on one side of the steam generating device 250.

In addition, on a top surface of the steam generating device 250, a steam discharge unit 252 for discharging the high-temperature/high-pressure steam generated inside the steam generating device 250 to the outside is formed. The steam discharge unit 252 includes a plurality of steam discharge pipes 252a whose entrance portions communicate with the inside of the steam generating device 250, a tteok product container seating flange 252b formed on an outlet of each of the steam discharge pipes 252a so that the tteok product container M to be cooked is seated on the seating flange 252b, and a steam discharge pin 252c constituted of a plurality of pipes which are formed to protrude from the bottom surface of the tteok product container seating flange 252b.

In this instance, in an edge portion of the tteok product container seating flange 252b, a side wall is preferably formed so that the bowl-shaped lower portion of the tteok product container M is stably seated on the tteok product container seating flange 252b.

In addition, the steam discharge pins 252c branch and discharge the high-temperature/high-pressure steam discharged via the steam generating device 250, the steam discharge pipe 252a, and the tteok product container seating flange 252b, and are preferably formed into a pin shape whose end portion is pointed so that the steam discharge pins 252c bore the lower surface of the tteok product container M seated on the tteok product container seating flange 252b to be inserted into the tteok product container M when cooking the tteok product.

In addition, an opening/closing valve (not shown) for controlling the pressure of the discharged steam or controlling steam discharge may be further provided in at least any one of the steam generating device 250 and the steam discharge pipe 252a.

In addition, a pressure sensor (not shown) or a water level sensor (not shown) may be further provided in the steam generating device 250, and the control unit 100 which will be described later may prevent over-pressure and overheating of the steam generating device by controlling water supply through the above-described heating device and the water supply pipe using the output of the pressure sensor or the water level sensor, which is disclosed in detail in [Document 1], etc., filed by the applicant of the present invention, and thus detailed description thereof will be omitted.

Meanwhile, the tteok product transport unit 280 includes a product transport arm support 281 that is installed on one side of the inner wall surface of the main body unit 10 to have a vertical bar shape, at least one product transport arm 282 that is rotatably coupled to the product transport arm support 281 to grip and transport the discharged tteok product container M, a panel-shaped product discharge board 285 that is installed at a location corresponding to the product discharge unit 60 so that the tteok product container M in which cooking is completed is placed, and a product discharge board support 286 that supports the product discharge board 285.

In this instance, it is preferable that an end portion of one side of the product transport arm 282 connected to the product transport arm support 281 be rotated with respect to the product transport arm support 281 as the axis by a driving device which is not shown, and the product transport arm 282 be elevated along a longitudinal direction of the product transport arm support 281, as necessary.

In addition, it is preferable that a gripping device that is operated like a hand by a driving device, which is not shown, to grip and transport one side of the tteok product container M be formed on an end portion of the other side of the product transport arm 282.

In addition, it is more preferable that the product transport arm 282 be configured in a hydraulic cylinder method so that the length of the product transport arm 282 can be adjusted.

In the product transport unit 280 configured as above, when the tteok product container M discharged from the refrigerating chamber 220 by selection of a consumer is placed on the tteok product seating portion 227, the product transport arm 282 grips the tteok product container M and seats the tteok product container M on the empty tteok product container seating flange 252b, and then pressurizes the tteok product container M downward, so that the steam discharge pin 252c can bore the lower surface of the tteok product container M to be inserted into the tteok product container M.

In addition, when cooking of the tteok product is completed by steam supply in a state in which the steam discharge pin 252c is inserted into the tteok product container M, the product transport arm 282 grips the tteok product container M and positions the tteok product container M on the product discharge board 285 so that the tteok product selected by a consumer is provided to the consumer through the product discharge unit 60.

In addition, a disuse chamber 260 for discarding the tteok product container M whose shelf life has expired is further provided on a lower one side space of the main body unit 10, and the product transport arm 282 grips the tteok product container M, whose shelf life has expired, discharged from the refrigerating chamber 220 and transports the tteok product container M to the disuse chamber 260 by control signals of the control unit 100.

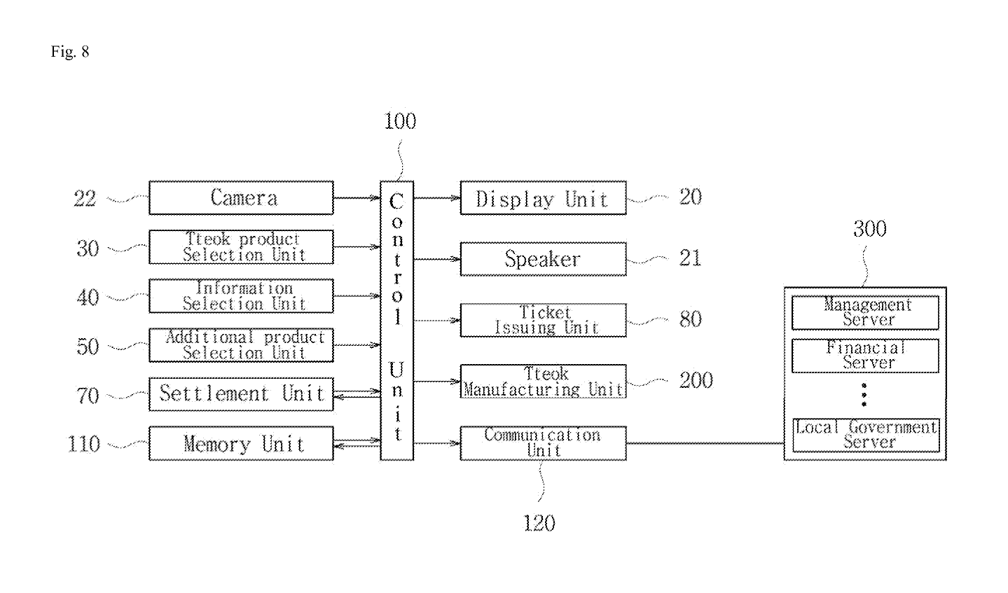

Hereinafter, an operational configuration of a multi-kiosk-based automatic tteok vending machine according to an exemplary embodiment of the present invention will be described with reference to FIG. 8.

First, when a consumer selects his or her required menu through the tteok product selection unit 30, the information selection unit 40, and the additional product selection unit 50, the control unit 100 provides contents or information related to the selected menu through the display unit 20 and/or the speaker 21 in an audio-visual manner, and controls operations of the ticket issuing unit 80, the communication unit 120, and the tteok manufacturing unit 200 in accordance with information or a program stored in the memory unit 110 in advance in order to execute the menu selected by the consumer.

In addition, the control unit 100 may provide an image acquired through the camera 22 to the consumer or the like through the display unit 20, as necessary, and when the consumer settles payment of his or her selected menu through the settlement unit 70, the control unit 100 may operate the communication unit 120 or the like in accordance with a predetermined method to settle the payment.

For example, when the consumer selects the tteok product, the control unit 100 may provide information about the origin, effect, and the like of the selected tteok product to the consumer through the display unit 20 while operating the tteok manufacturing unit 200.

In this instance, the control unit 100 may control a pressure, a supply time, a temperature, and the like of the steam supplied to the tteok product container M in accordance with an algorithm stored in the memory unit 110 in advance, and control operations of the above-described heating device and water supply through the water supply pipe in order to maintain the internal temperature and pressure of the steam generating device 250 at a safe level.

In addition, when the consumer selects information or the additional product or desires to settle payment using a mobile phone terminal or a credit card, the control unit 100 may provide a progress status for each operation or error information to the consumer through the display unit 20 while performing the selected operation in accordance with a predetermined method.

In this instance, the control unit 100 may perform procedures such as providing of explanation of the information selected by the consumer and explanation of the additional product, sales, reservation, or authentication for a settlement means, payment authorization, and the like by communicating with the external server 300 connected through the communication unit 120, which may be preferably implemented by a method generally adopted in a normal kiosk system.

In this case, as an example, the external server 300 may be a management server of the apparatus, a financial server, a local government server, a server of an agency for issuing vouchers or the like, or a server operated by a person who does business for these.

As described above, according to the present invention, the multi-kiosk-based automatic tteok vending machine may be provided in the form of a vending machine so that, when a consumer selects a desired kind of tteok product, one side of a tteok product container with the material of a corresponding tteok product airtightly packaged therein may be bored and high-pressure steam may be supplied directly to the inside of the bored tteok product container in a state in which a steam discharge pin is inserted into the bored one side of the tteok product container, whereby tteok can be easily cooked on the spot to be provided, and the tteok product container may be sealed so that it is possible to prevent decomposition of the ingredient of the tteok.

In addition, the multi-kiosk-based automatic tteok vending machine may additionally provide a variety of information and services to consumers by a multi-kiosk system connected to an external server, and include a sunlight generation system, and thereby may be installed in a remote location or the like in which power supply is not smoothly performed.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

### INDUSTRIAL AVAILABILITY

The present invention relates to a multi-kiosk-based automatic tteok vending machine using rice as a primary material so that the multi-kiosk-based automatic tteok vending machine may contribute to promote rice consumption in the agricultural field, and adopts a multi-kiosk system and thereby may be used in information service industries, and the like.

1. A multi-kiosk-based automatic tteok vending machine comprising:
a tteok product selection unit that is installed on one side of an outer surface of a box-like main body and in which signals for selecting at least any one menu of tteok products being on sale are input;
a tteok product preserving unit that preserves, in an internal space of the main body, a product container in which a material of each of the tteok products is individually and airtightly packaged, and discharges the product container in which a corresponding tteok product is packaged when the menu of the tteok product is selected; and
a tteok manufacturing unit that cooks the tteok product by supplying steam into the product container discharged from the tteok product preserving unit in the internal space of the main body,
wherein the tteok manufacturing unit includes a steam generating device for generating high-temperature steam and a steam discharging device for supplying the generated steam into the product container to cook the tteok product, and the steam is supplied in a state in which the steam discharging device bores one side of the product container and at least a part of the steam discharging device is inserted into the product container.

2. The multi-kiosk-based automatic tteok vending machine of claim 1, wherein
the tteok manufacturing unit further includes a container transport device for transporting the product container discharged from the tteok product preserving unit to the steam generating device and transporting the product container in which cooking of the tteok product is completed to a product discharge unit formed on the outer surface of the main body,
the steam discharging device includes a steam discharge pipe that discharges the steam generated in the steam generating device to the outside, a flange that is formed in an end portion of the steam discharge pipe so that the product container is seated on the flange, and a plurality of steam discharge pins which are installed so as to protrude in the form of pins from a bottom surface of the flange to branch and discharge the steam of the steam discharge pipe, and
the container transport device transports the product container to the flange to seat the product container in the flange and then pressures the product container downward so that the steam discharge pins bore a seated surface of the product container and are inserted into the product container.

3. The multi-kiosk-based automatic tteok vending machine of claim 1, further comprising:
an information selection unit that is installed on one side of the outer surface of the main body and in which signals for selecting at least any one menu of information being provided either for free or for pay are input; and
an additional product selection unit that is provided on one side of the outer surface of the main body and in which signals for selecting at least any one menu of other additional products being on sale are input.

4. The multi-kiosk-based automatic tteok vending machine of claim 3, further comprising:
a display unit that is installed on one side of the outer surface of the main body,
wherein the display unit displays, when at least any one menu is selected in the tteok product selection unit, the information selection unit, or the additional product selection unit, information related to the selected menu.

5. The multi-kiosk-based automatic tteok vending machine of claim 4, wherein the display unit is configured in a touch screen scheme, and
the tteok product selection unit, the information selection unit, or the additional product selection unit are displayed on a screen of the display unit so that the menu is selected by a touch.

6. The multi-kiosk-based automatic tteok vending machine of claim 3, further comprising:
a ticket issuing unit that is provided on one side of the outer surface of the main body to issue and provide the additional product being on sale in a ticket format.

7. The multi-kiosk-based automatic tteok vending machine of claim 3, further comprising:
a settlement unit that settles payment of the menu selected in the tteok product selection unit, the information selection unit, or the additional product selection unit,
wherein the settlement unit includes at least any one of a voucher settlement machine in which payment is performed by a voucher, a mobile phone settlement machine in which payment is performed by a mobile phone terminal, a cash settlement machine in which payment is performed by cash such as coins or bills, and a credit card settlement machine in which payment is performed by a credit card or the like.

8. The multi-kiosk-based automatic tteok vending machine of claim 3,
further comprising:
a communication unit that communicates with an external server,
wherein the external server is a server operated by at least any one of an agency for providing information of the menu selected in the information selection unit, an agency for selling the additional product selected in the additional product selection unit, an agency for processing payment by the mobile phone terminal, an agency for processing payment by the credit card, and an agency for doing business for these agencies.

9. The multi-kiosk-based automatic tteok vending machine of claim 1, wherein the tteok product preserving unit includes a freezing chamber for freezing and preserving the product container and a refrigerating chamber for refrigerating and preserving the product container, and
the freezing chamber discharges the product container of the selected tteok product to the refrigerating chamber when the product container of the selected tteok product is discharged from the refrigerating chamber by selection of the menu of the tteok product.

10. The multi-kiosk-based automatic tteok vending machine of claim 1, wherein the steam generating device includes a water tank with water accommodated therein, and a heating device that is installed on one side of the water tank to heat water inside the water tank by electromagnetic induction.
